(19) United States
(12) Patent Application Publication
(10) Pub. No.: US 2009/0309953 A1
(43) Pub. Date: Dec. 17, 2009

(54) DRAWING DEVICE AND METHOD, AND COMPUTER PROGRAM

(75) Inventor: Tetsuya Hayashi, Tokorozawa-shi (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/519,619

(22) PCT Filed: Dec. 25, 2006
(86) PCT No.: PCT/JP2006/325722

§ 371 Date: Sep. 1, 2009

(51) Int. Cl. B41J 2/47

(52) U.S. Cl. 347/225

(57) ABSTRACT

A drawing device (1) for performing drawing processing for drawing a desired pattern on a label surface (122) of a recording medium. The drawing device (1) has input element (42) for receiving from a user a desired pattern to be drawn, drawing element (13) for drawing the received desired pattern on the label surface by applying a laser beam to the label surface, and management information recording element (32) for recording, each time when a desired pattern is drawn on a label surface, management information in which the desired pattern drawn and identification information unique to the recording medium having the label surface on which the drawing is made are associated with each other.

### TECHNICAL FIELD

The present invention relates to a drawing apparatus for and method of drawing a pattern such as a character or a letter, a graphic, and an image, for example, onto a label surface of a recording medium, and a computer program.

### BACKGROUND ART

An optical disc such as a CD and a DVD allows large volumes of data to be recorded thereon easily. As the data recorded on the optical disc, for example, software, computer applications, computer files, video data, music data, and the like are listed as one specific example. Such an optical disc stores the data digitally. More specifically, a high-intensity laser beam is used to burn a small area of the optical disc (i.e. to change optical properties in the small area), so that a pit pattern according to the data to be recorded makes each small area reflective or unreflective. By this, it is possible to record the data onto the optical disc.

In recent years, in such an optical disc, a user's desired pattern (e.g. a desired image, character or letter, graphic, and the like) has been frequently drawn on a label surface, which is a surface on the opposite side of a recording surface on which the data is recorded. Typically, a simple action of using a pen or the like to draw the desired pattern and an action of using an ink jet printer to draw the desired pattern can be listed as one specific example.

On the other hand, as a technology of drawing the desired pattern, there has been developed a technology of laminating a pigmented film or the like on the label surface and applying a laser beam to the label surface (i.e. the pigmented film), thereby drawing the desired pattern onto the label surface (refer to patent documents 1 and 2). According to this technology, since the desired pattern can be drawn on the label surface using a hardware configuration for recording the data (specifically, an optical pickup or the like), it is possible to draw the clear image, character or letter, graphic, and the like on the label surface, relatively easily.

Patent document 1: US Patent Publication No. 6771297
Patent document 2: Japanese Patent Application Laid Open No. 2006-511034

### DISCLOSURE OF INVENTION

### Subject To Be Solved By The Invention

By the way, in the technology of drawing the desired pattern onto the label surface, drawn images or the like possibly overlap depending on conditions in the drawing. Normally, unlike a pencil, the drawing on the label surface is hardly deleted, and once such overlap is generated, it could be irreparable. Specifically, not only the image drawn this time but also the images that have been drawn so far on the label surface are possibly destroyed.

In view of the aforementioned problems, it is therefore an object of the present invention to provide a drawing apparatus and method which can draw the desired pattern without overlap on the label surface of a recording medium, and a computer program for operating a computer as such a drawing apparatus.

### Means For Solving The Subject

The above object of the present invention can be achieved by a drawing apparatus for performing a drawing processing for drawing a desired pattern onto a label surface provided for a recording medium, the drawing apparatus provided with: an inputting device for receiving the desired pattern to be drawn, from a user; a drawing device for drawing the received desired pattern onto the label surface by applying a laser beam to the label surface; and a management information recording device for recording the drawn desired pattern and management information associated with identification information unique to the recording medium provided with the label surface on which the desired pattern is drawn, every time the desired pattern is drawn onto the label surface.

The above object of the present invention can be also achieved by a drawing method in a drawing apparatus for performing a drawing processing for drawing a desired pattern onto a label surface provided for a recording medium, the drawing method provided with: an inputting process of receiving the desired pattern to be drawn, from a user; a drawing process of drawing the received desired pattern onto the label surface by applying a laser beam to the label surface; and a management information recording process of recording the drawn desired pattern and management information associated with identification information unique to the recording medium provided with the label surface on which the desired pattern is drawn, every time the desired pattern is drawn onto the label surface.

The above object of the present invention can be also achieved by a computer program for controlling a computer provided in a drawing apparatus for performing a drawing processing for drawing a desired pattern onto a label surface provided for a recording medium, the drawing apparatus provided with: an inputting device for receiving the desired pattern to be drawn, from a user; a drawing device for drawing the received desired pattern onto the label surface by applying a laser beam to the label surface; and a management information recording device for recording the drawn desired pattern and management information associated with identification information unique to the recording medium provided with the label surface on which the desired pattern is drawn, every time the desired pattern is drawn onto the label surface, the computer program making a computer function as at least the management information recording device.

These operation and other advantages of the present invention will become more apparent from the embodiments explained below.

### BRIEF DESCRIPTION OF DRAWINGS

FIG. 1 is a block diagram conceptually showing the basic structure of a recording/reproducing apparatus in a first example.

FIG. 2 is a plan view showing the basic structure of an optical disc which is a target for the recording/reproducing apparatus in the first example.

FIG. 3 are plan views conceptually showing a label drawn by an information recording/reproducing apparatus in a comparison example.

FIG. 4 are plan views conceptually showing a label drawn by an information recording/reproducing apparatus 1 in the first example.

FIG. 5 is a flowchart conceptually showing a flow of a drawing management processing in the first example.

FIG. 6 is a flowchart conceptually showing a flow of a drawing processing in the drawing management processing in the first example.

FIG. 7 is a flowchart conceptually showing a flow of a drawing management processing in a second example.

FIG. 8 is a plan view showing a warning screen in the second example.

FIG. 9 are plan views conceptually showing that a data recorded area on a recording surface of an optical disc in a third example is displayed on a display device.

FIG. 10 are plan views showing that a remaining recordable capacity is displayed on the display device in the third example.

FIG. 11 are plan views conceptually showing that a plurality of data recorded areas and a drawn area on the recording surface of the optical disc in the third example are displayed on the display device.

### DESCRIPTION OF REFERENCE CODES

1 information recording/reproducing apparatus
11 spindle motor
12 optical pickup unit
13 optical pickup
14 thread
15 stepping motor
51 encoder
52 encoder controller
16 OPU controller
17 stepping controller
18 spindle controller
21 data bus
31 system controller
32 memory
41 display device
42 input device
100 optical disc
10 data recording layer
120 label layer
121 characteristic data recording area
122 label area
1211, 1212, 1213 pattern
101 virtual optical disc
1221 virtual label area
131 previous virtual label
130 previous label
141 current virtual label
140 current label
160 first data area
161 virtual first data area
112 recording surface (and label area)
1121 virtual recording surface
170 second data area (for additional recording)
171 virtual second data area
152 balloon (for displaying a remaining recordable capacity)

### BEST MODE FOR CARRYING OUT THE INVENTION

Hereinafter, as the best mode for carrying out the present invention, an explanation will be given on embodiments of the drawing apparatus and method, and the computer program of the present invention.

### Embodiment of Drawing Apparatus

An embodiment of the drawing apparatus of the present invention is a drawing apparatus for performing a drawing processing for drawing a desired pattern onto a label surface provided for a recording medium, the drawing apparatus provided with: an inputting device for receiving the desired pattern to be drawn, from a user; a drawing device for drawing the received desired pattern onto the label surface by applying a laser beam to the label surface; and a management information recording device for recording the drawn desired pattern and management information associated with identification information unique to the recording medium provided with the label surface on which the desired pattern is drawn, every time the desired pattern is drawn onto the label surface.

According to the embodiment of the drawing apparatus of the present invention, for example, it is possible to draw the desired pattern without overlap, onto the label surface of the recording medium, on the basis of the management information. More specifically, firstly, the drawing apparatus is a drawing apparatus for performing the drawing processing for drawing the desired pattern onto the label surface (which indicates a surface on the side that is a drawing target of the both surfaces of an optical disc and which typically indicates a surface on the opposite side of a recording surface, but which may also indicate a surface on the same side) provided for the recording medium (e.g. an optical disc such as a CD, a DVD, and a BD).

Here, the desired pattern to be drawn (e.g. the shape, size, placement, and the like of a desired image, a desired characteristic or letter, and a desired graphic) is received from the user through tine inputting device (e.g. a mouse, a keyboard, a touch panel, or the like).

The desired pattern received in this manner is drawn by the drawing device (e.g. an optical pickup having a semiconductor laser device or the like) onto the label surface by applying the laser beam to the label surface. Specifically, the drawing device can be displaced in a radial direction of the recording medium (in other words, a tracking direction) along the label surface. Moreover, a pigmented film or the like is applied on the label surface, and the desired pattern is drawn onto the label surface by using a difference between the reflectance of the pigmented film in a portion that is irradiated with the laser beam and the reflectance of the pigmented film in a portion that is not irradiated with the laser beam.

As described above, every time the desired pattern is drawn onto the label surface, the management information is recorded by the management information recording device (e.g. a memory or the like). The management information herein is information in which the drawn desired pattern (e.g. image data such as bitmap and vector data) is associated with the identification information unique to the recording medium provided with the label surface in which the desired pattern is drawn (e.g. an identification number prerecorded on either the label surface of the recording surface).

Here, if the recording medium is only directly visually recognized, it is hard to accurately recognize the placement and size of the desired pattern drawn in the drawing processing so far. If the desired pattern newly received in the current drawing processing is additionally drawn on the basis of the inaccurate recognition, the drawn images or the like possibly overlap, depending on conditions in the drawing.

However, by using the management information and optically reading the unique identification information recorded on the recording medium, it is possible to easily read the desired pattern drawn so far on the recording medium from the management information recording device, on the basis of the management information corresponding to the read identification information. As described above, the desired pattern drawn so far can be simply specified on the basis of the management information. Thus, for example, by a displaying device described later displaying the desired pattern drawn so far as a rough sketch and displaying the desired pattern received in the current drawing processing thereon, the user can confirm a final look before performing the drawing processing.

As is seen above, according to the embodiment of the drawing apparatus of the present invention, for example, it is possible to draw the desired pattern without overlap onto the label surface of the recording medium, and it is extremely useful in practice.

In one aspect of the embodiment of the drawing apparatus of the present invention, it is further provided with a displaying device for displaying the desired pattern drawn on the recording medium in the drawing processing performed previous time or before the previous time, as a drawing history, on the basis of the recorded management information.

According to this aspect, the aforementioned drawing processing is more preferably performed. More specifically, the drawing history (i.e. the desired pattern drawn on the recording medium in the drawing processing performed the previous time or before the previous time) is displayed on the displaying device (e.g. a display apparatus having a screen) on the basis of the recorded management information. Here, for example, if the drawing history and the described pattern received in the current drawing processing are displayed in the same screen, the user can confirm a final look before performing the drawing processing. As described above, according to this aspect, the aforementioned drawing processing is more preferably performed, so that it is extremely useful in practice.

In an aspect in which the drawing history is displayed, it may be further provided with a judging device for performing a judgment processing of judging whether or not there is overlap on the label surface between the drawing history and the desired pattern received in a current drawing processing.

According to this aspect, since the user can recognize the overlap before performing the current drawing processing, the user can properly deal with the overlap. More specifically, it is judged by the judging device (e.g. a controller having an arithmetic circuit) whether or not there is the overlap on the label surface between the drawing history and the desired pattern received in the current drawing processing. For example, since it is possible to specify coordinates occupied by the both patterns on the label surface from image data (e.g. bit map and vector data or the like) for drawing the both patterns, whether or not there is the overlap is judged by specifying the overlap of the both coordinates. The “overlap” herein may include not only the presence or absence of the overlap but also the extent of the overlap or at which position the overlap occurs or the like. As described above, the user can recognize the overlap before performing the current drawing processing, so that the user can properly deal with the overlap.

In an aspect in which the overlap is judged, it may be further provided with a warning device for giving a predetermined warning to the user if it is judged in the judgment processing that there is the overlap.

According to this aspect, the drawing overlap can be preferably avoided. More specifically, if it is judged that there is the overlap in the aforementioned judgment processing, the predetermined warning is given to the user by the warning device (e.g. a controller having an arithmetic circuit). The “warning” herein notifies the user of the occurrence of some not-preferable situation in performing the drawing processing, and a warning may be displayed on the displaying device, or a warning beep may be made. As described above, if the warning is given, the user can modify the desired pattern before drawing it as occasion demands, so that the aforementioned drawing overlap can be preferably avoided.

Alternatively, in an aspect in which the overlap is judged, it may be further provided with a modifying device for displacing or reducing the desired pattern received in the current drawing processing so as to reduce extent of the overlap if it is judged in the judgment processing that there is the overlap.

According to this aspect, the drawing overlap can be avoided, relatively easily. More specifically, if it is judged that there is the overlap in the judgment processing, the desired pattern received in the current drawing processing is displaced or reduced by the modifying deice (e.g. a controller having an arithmetic circuit) so as to reduce the extent of the overlap. For example, the desired pattern may be displaced in a predetermined direction by a distance at the same level as the width of the overlap in the same direction. Alternatively, a free space (i.e. an area in which nothing has been drawn) on the label surface may be searched for, and the desired pattern may be reduced to fit in the free space and displaced. Alternatively, there may be a form for disposing each pattern in advance (e.g. a form for disposing the pattern in tandem, a form for disposing the pattern along the outer shape of the recording medium, or the like), and the desired pattern may be displaced or reduced in accordance with the form. As described above, the desired pattern is automatically modified, so that the drawing overlap can be avoided relatively easily.

According to this aspect, it is further provided with a reading device for reading the drawing history by optically scanning the label surface if the management information is not recorded, the displaying device displaying the read desired pattern.

According to this aspect, even if the management information is not recorded, the overlap can be avoided. More specifically, even if the management information is not recorded, the label surface is optically searched by the reading device (e.g. an optical pickup which is commonly used (or shared) by the drawing device and which has a semiconductor laser device and a light receiving element), by which the drawing history is read. The “optically scanning” herein indicates emitting the laser beam with a weaker power than in the drawing and reading the reflected light, and it in effect uses the difference in the reflectance between the pigmented film in a portion in which the desired pattern is drawn and the pigmented film in a portion in which the desired pattern is not drawn. Since the desired pattern read in this manner is displayed by the displaying device, the user can look at it and modify the desired pattern before drawing it as occasion demands. As described above, even if the management information is not recorded, the overlap can be avoided.

In another aspect of the embodiment of the drawing apparatus of the present invention, it is further provided with a data recording device (e.g. a pickup common to the drawing device) which can record data onto a recording surface, only once or additionally, if the drawing apparatus performs the drawing onto the recording surface of the recording medium as the label surface (e.g. if performing the drawing in a DiscT@2 method), the management information recording device recording a data recorded area (e.g. track information and two-dimensional coordinate, or the like) on the recording surface, in addition to the drawn desired pattern, as the management information.

According to this aspect, of the recording surface of the recording medium, it is possible to judge not only an area in which the desired pattern is drawn and an undrawn area, but also an area in which the data is recorded and an unrecorded area. Therefore, it is possible to avoid a situation that the desired pattern is drawn into the data recorded area and a situation that the data is recorded into the area in which the desired pattern is drawn: a situation that the drawing deteriorates recording quality.

In an aspect in which the data recorded area is recorded as the management information, as described above, the displaying device further displays the data recorded area.

According to this aspect, the user can dispose the desired pattern not to overlap not only the desired pattern drawn in the past but also the data recorded area, while confirming the displayed content.

In an aspect in which the data recorded area is further displayed as described above, the displaying device further displays an area in which data is scheduled to be additionally recorded by the data recording device (this area is also obviously received by the drawing device).

According to this aspect, the user can dispose the desired pattern not to overlap not only the data recorded area but also the area in which the data is to be additionally recorded, while confirming the displayed content.

Alternatively, in an aspect in which the data recorded area is also recorded as the management information, as described above, it may be further provided with a calculating device (e.g. a system controller) for calculating a remaining recordable capacity corresponding to an area in which data additional recording is possible on the recording surface, on the basis of the recorded management information.

According to this aspect, the remaining recordable capacity is calculated by the calculating device, as occasion demands. Specifically, for example, the remaining recordable capacity is calculated as a difference between an outermost track of the tracks occupied by the data recorded area and an innermost track of the tracks occupied by the desired pattern (including not only the drawn pattern but also the pattern which is scheduled to be additionally drawn) if the data is additionally recorded continuously to the data recorded area toward the outer circumferential side. The difference may be provided with a slight margin. Incidentally, as opposed to this, if the data recording direction is directed to the inner circumferential side, then obviously, the calculation target for the difference also varies in accordance with the direction. Moreover, if the data can be additionally recorded on the further outer circumferential side with the desired pattern skipped, a difference between the outermost track of the tracks occupied by the desired pattern and the outermost track of the tracks on the recording surface may be added to the aforementioned difference. In any cases, since the remaining recordable capacity is calculated in this manner, convenience improves when the user is thinking of the additional recording of the data.

In an aspect in which the remaining recordable capacity is calculated, as described above, the displaying device may further display the calculated remaining recordable capacity.

According to this aspect, the user can dispose the desired pattern scheduled to be additionally drawn from now, while confirming the remaining recordable capacity. Moreover, from the minimum recording capacity to be desirably ensured, an area in which the placement of the desired pattern is allowed may be displayed.

### Embodiment of Drawing Method

An embodiment of the drawing apparatus of the present invention is a drawing method in a drawing apparatus for performing a drawing processing for drawing a desired pattern onto a label surface provided for a recording medium, the drawing method provided with: an inputting process of receiving the desired pattern to be drawn, from a user; a drawing process of drawing the received desired pattern onto the label surface by applying a laser beam to the label surface; and a management information recording process of recording the drawn desired pattern and management information associated with identification information unique to the recording medium provided with the label surface on which the desired pattern is drawn, every time the desired pattern is drawn onto the label surface.

The embodiment of the drawing method of the present invention can receive the same various effects as those that can be received by the aforementioned embodiment of the drawing apparatus of the present invention.

Incidentally, in response to the aforementioned various aspects in the embodiment of the drawing apparatus of the present invention, the embodiment of the drawing method of the present invention can also adopt various aspects.

### Embodiment of Computer Program

An embodiment of the computer program of the present invention is a computer program for controlling a computer provided in a drawing apparatus for performing a drawing processing for drawing a desired pattern onto a label surface provided for a recording medium, the drawing apparatus provided with: an inputting device for receiving the desired pattern to be drawn, from a user; a drawing device for drawing the received desired pattern onto the label surface by applying a laser beam to the label surface; and a management information recording device for recording the drawn desired pattern and management information associated with identification information unique to the recording medium provided with the label surface on which the desired pattern is drawn, every time the desired pattern is drawn onto the label surface, the computer program making a computer function as at least the management information recording device.

According to the embodiment of the computer program of the present invention, the aforementioned embodiment of the drawing apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the aforementioned various aspects in the embodiment of the drawing apparatus of the present invention, the embodiment of the computer program of the present invention can also adopt various aspects.

An embodiment of the computer program product of the present invention makes the computer function as at least the management information recording device.

According to the embodiment of the computer program product of the present invention, the aforementioned embodiment of the drawing apparatus of the present invention can be embodied relatively readily, by loading the computer program product from a recording medium for storing the computer program product, such as a ROM, a CD-ROM, a DVD-ROM, a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned embodiment of the drawing apparatus of the present invention.

Incidentally, in response to the aforementioned various aspects in the embodiment of the drawing apparatus of the present invention, the embodiment of the computer program product of the present invention can also adopt various aspects.

These operation and other advantages of the present invention will become more apparent from the examples explained below.

As explained above, according to the embodiment of the drawing apparatus of the present invention, it is provided with the inputting device, the drawing device, and the management information recording device. According to the embodiment of the drawing method of the present invention, it is provided with the inputting process, the drawing process, and the management information recording process. According to the embodiment of the computer program of the present invention, it makes a computer function as at least the management information recording device. Therefore, it is possible to draw the desired pattern without overlap in the drawing processing.

### EXAMPLES

Hereinafter, examples of the present invention will be explained with reference to the drawings. Incidentally, the following examples are explained by using the construction that the drawing apparatus or the like of the present invention is applied to an information recording I reproducing apparatus for an optical disc.

### (1) First Example

### (1-1) Basic Structure

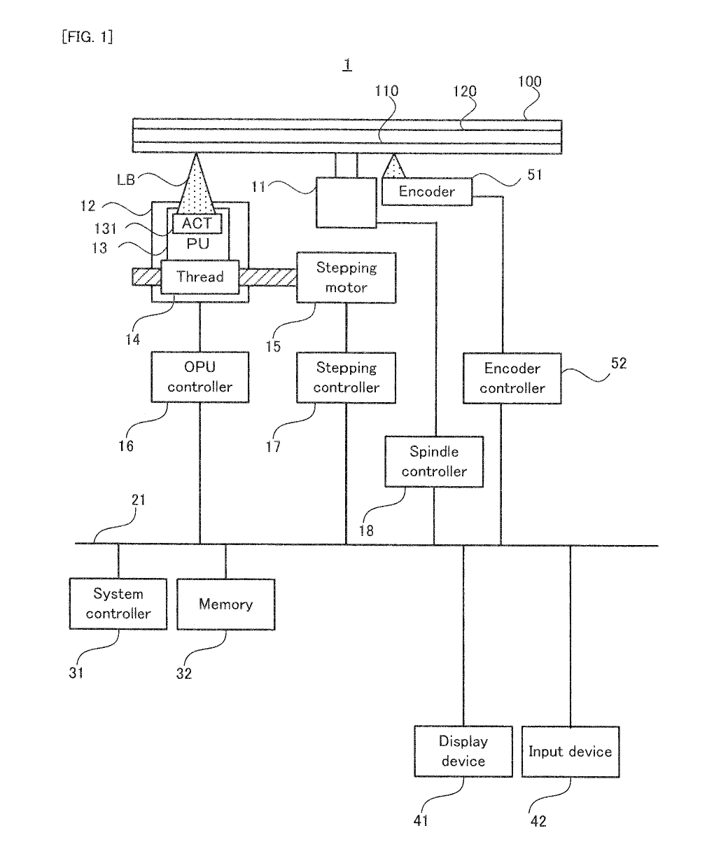

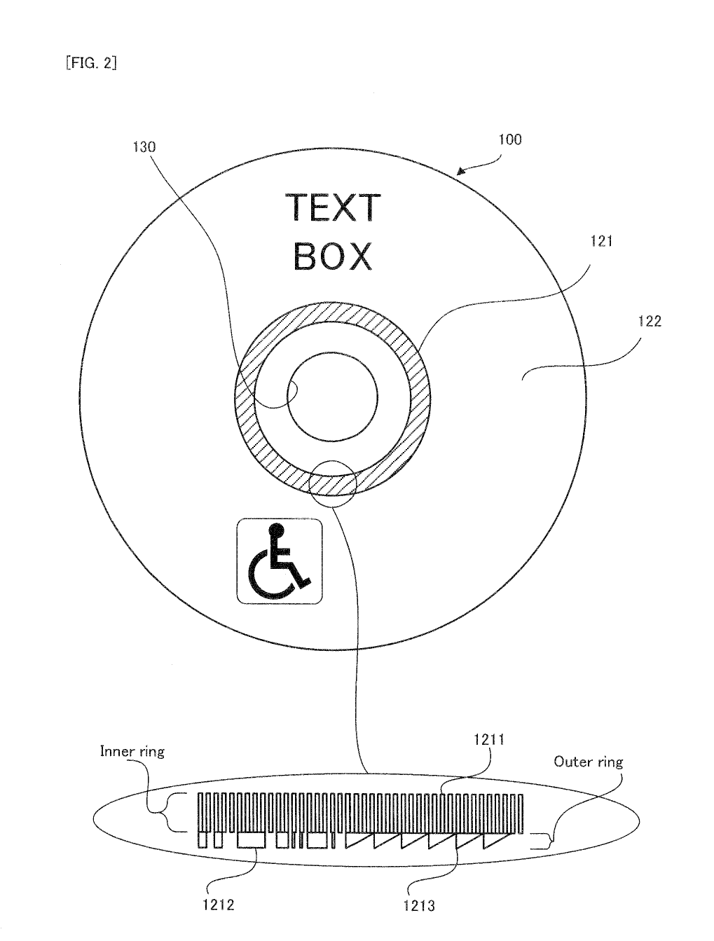

Firstly, with reference to FIG. 1 and FIG. 2, an explanation will be given on the basic structures of an information recording/reproducing apparatus in a first example and an optical disc which is a target for the operations by the information recording/reproducing apparatus. FIG. 1 is a block diagram conceptually showing the basic structure of the recording/reproducing apparatus in the first example. FIG. 2 is a plan view showing the basic structure of the optical disc which is a target for the operations of the recording/reproducing apparatus in the first example.

As shown in FIG. 1, an information recording/reproducing apparatus 1 in the example is provided with a spindle motor 11, an optical pickup (OPU) unit 12, an optical pickup 13, a thread 14, a stepping motor 15, an encoder 51, a display device 41, an input device 42, an OPU controller 16, a stepping controller 17, a spindle controller 18, a system controller 31, and a memory 32.

The spindle motor 11 is a motor for rotating and stopping an optical disc 100. More specifically, the spindle motor 11 is adapted to rotate the optical disc 100 at a predetermined speed and stop it, under spindle servo under the control of the spindle controller 18.

The optical pickup unit 12 is a case for holding the optical pickup 13 and the thread 14.

The thread 14 is subjected to a driving force by the stepping motor 15 and is displaced in a radial direction of the optical disc 100 with the optical pickup unit 12.

The optical pickup 13 constitutes one specific example of the “drawing device” and the “data recording device” of the present invention. The optical pickup 13 is provided with, for example, a semiconductor laser device, a collimator lens, a light receiving element, an objective lens, which are not illustrated, and an actuator 131 or the like capable of oscillating a lens holder for the objective lens with respect to a plurality of axes, in order to perform data recording and reproduction on the optical disc 100. In the optical pickup 13, the position in the radial direction of the optical disc 100 is adjusted by the displacement of the thread 14 by the stepping motor 15, and the position is further finely adjusted by the actuator 131 disposed in the optical pickup unit 12. In other words, the position of the optical pickup 13 is determined by the displacement of the thread 14 by the stepping motor 15, and then, the irradiation position of a laser beam LB is determined by the actuator 131 which can move with higher resolution. At this time, in order to improve the displacement accuracy of the thread 14, the displacement may be performed using only a two-phase displacement position which has a high magnetic force. Moreover, the optical pickup 13 applies the laser beam LB to the optical disc 100 as reading light with a first power in the reproduction, and as writing light with a second power with it modulated in the recording. In addition, the optical pickup 13 applies the laser beam LB to the optical disc 100 in performing label drawing on the optical disc 100.

The stepping motor 15 displaces the thread 14 in the radial direction of the optical disc 100, in accordance with a voltage applied by the stepping controller 17.

The encoder 51 applies a laser beam to a characteristic data recording area 121 (refer to FIG. 2) of the optical disc 100 under the control of an encoder controller 52, and it receives the reflected light by a light receiving element, thereby obtaining velocity information and angle information about the optical disc 100.

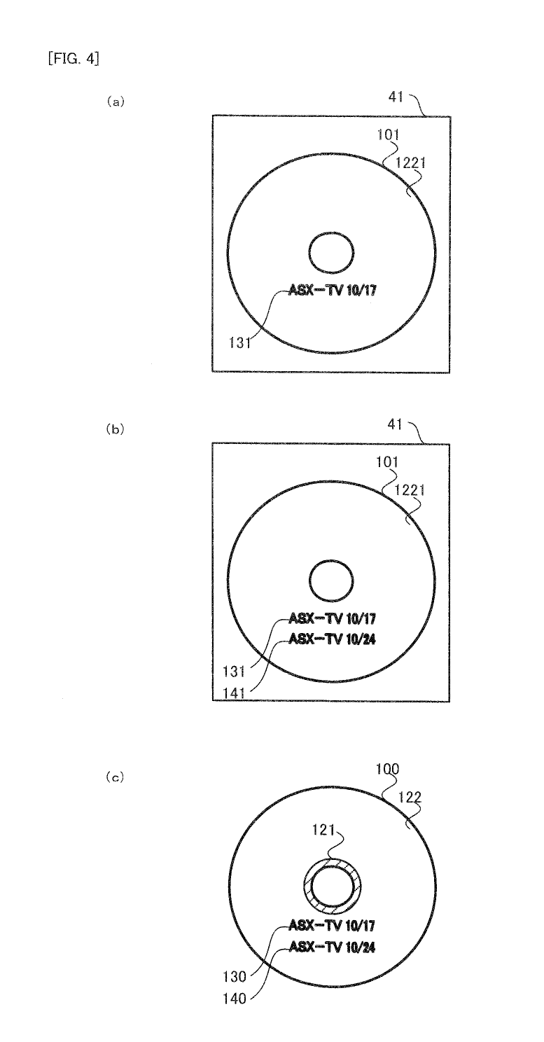

The display device 41 has, for example, a liquid crystal display or a plasma display or the like, and it functions as a user interface in performing the label drawing. For example, the display device 41 displays a reading result of the data recorded in a data recording layer 110 of the optical disc 100. In addition, the display device 41 displaces a desired pattern to be drawn into a label layer 120 (refer to FIG. 4). A history of the desired patterns is recorded in the memory 32 in association with management information about the optical disc 100, and a user can specify a new pattern through the input device 42 while looking at the history of the desired patterns displayed on the display device 41.

The input device 42 constitutes one specific example of the “inputting device” of the present invention. The input device 42 is a tablet-type display unified with, for example, a keyboard, a mouse, or the display device 41. The input device 42 receives various inputs such as information for forming the desired pattern (e.g. a character or letter, a command, coordinate information), from a user. The received input is transmitted to the system controller 31 through the data bus 21. In accordance with the content, the desired pattern displayed on the display device 41 is changed, or a predetermined operation processing is performed by the information recording/reproducing apparatus 1.

The OPU controller 16 is provided with, for example, a laser diode driver or the like, and it controls an operation of applying the laser beam LB by the optical pickup 13. Specifically, the OPU controller 16 controls the power, irradiation timing, irradiation position and the like of the laser beam LB (in other words, the operations of the optical pickup 13) in cooperation with the stepping controller 17, the spindle controller 18, and the encoder controller 52, under the control of the system controller 31.

The stepping controller 17 controls the voltage to be applied to the stepping motor 15, thereby controlling the displacement or travel distance of the thread 14 by the stepping motor 15. Specifically, the stepping controller 17 controls the displacement of the thread 14 (in other words, the operations of the stepping motor 15) in cooperation with the OPU controller 16 and the spindle controller 18, under the control of the system controller 31.

The spindle controller 18 controls the rotation of the optical disc 100 by the spindle motor 11. Specifically, the spindle controller 18 controls the rotational speed, rotational angle, or the like of the optical disc 100 (in other words, the operations of the spindle motor 11) in cooperation with the OPU controller 16 and the stepping controller 17, under the control of the system controller 31.

The system controller 31 is connected to the display device 41, the input device 42, the OPU controller 16, the stepping controller 17, the spindle controller 18, and the memory 32 through the data bus 21. The system controller 31 outputs a control command to each of the OPU controller 16, the stepping controller 17, and the spindle controller 18, thereby controlling the entire information recording/reproducing apparatus 1. Moreover, the system controller 31 allows the display device 41 to display a motion picture (in particular, the desired pattern) based on the input information from the input device 42 and the memory 32 to store the input device therein. Normally, software or firmware for the system controller 31 operating is stored in the memory 32.

The memory 32 constitutes one specific example of the “management information recording device” of the present invention. The memory 32 is provided with a ROM area which stores therein a program for the information recording/reproducing apparatus 1 operating (i.e. firmware); a RAM area which temporarily stores therein data used during the operations by the information recording/reproducing apparatus 1; and the like. In addition, software for label drawing (in other words, application for drawing) and management information or the like about the label to be drawn are also stored in the memory 32. On the basis of the management information recorded in this manner, the system controller 31 which constitutes one specific example of the “calculating device” of the present invention can calculate the remaining recordable capacity of the optical disc, as occasion demands.

Incidentally, the optical disc 100, which is the target for the operations of the recording/reproducing apparatus in the example, has a circular shape as in a DVD, for example, as shown in FIG. 1 and FIG. 2, and the optical disc 100 has the recording layer 110 laminated on one side and the label layer 120 laminated on the other side. The data recording layer 110 is irradiated with the laser beam LB from the lower side in FIG. 1, by which the data is recorded and reproduced. On the other hand, the label layer 120 is irradiated with the laser beam LB from the upper side in FIG. 1 (actually, from the lower side in FIG. 1 with the optical disc 100 turned over), by which the label is drawn.

The data recording layer 110 of the optical disc 100 is provided with, for example, a pigmented film or a phase change film whose properties (e.g. reflective properties) are changed by the irradiation of the laser beam LB. The data recording layer 110 is provided with a lead-in area, a user data area, and a lead-out area, centered on a center hole 130 (refer to FIG. 2). The data recording layer 110 also has a track such as a groove track and a land track, alternately placed spirally or concentrically, centered on the center hole 130. Moreover, on the track, the data is divided and recorded by a unit of ECC block. The ECC block is a data management unit by which the data can be error-corrected.

On the other hand, the label layer 120 of the optical disc 100 is provided with, for example, a pigmented film whose properties (e.g. reflective properties) are changed by the irradiation of the laser beam LB. The label layer 120 is not provided with the aforementioned track; however, obviously, it may be also provided with the track. The label layer 120 is provided particularly with a characteristic data recording area 121 on the innermost side and a label area 122 in which the label (i.e. one specific example of the “desired pattern” of the present invention) is actually drawn on the outer side of the characteristic data recording area 121.

The characteristic data recording area 121, as shown in the enlarged view thereof shown on the lower side in FIG. 2, has a pattern 1211 formed, in which a rectangular pattern that has a high optical reflectance and a rectangular pattern that has the same size as the rectangular pattern with a high optical reflectance and that has a low optical reflectance are regularly arranged. The pattern 1211 is read by the encoder 51. The pattern 1211 enables the information recording/reproducing apparatus 1 to obtain information about the velocity of the optical disc 100 (specifically, angular velocity or rotational speed), in performing the label drawing into the label area 122. By this, the information recording/reproducing apparatus 1 can adjust or recognize the velocity of the optical disc 100 in performing the label drawing into the label area 122.

The characteristic data recording area 121, as shown in the enlarged view thereof shown on the lower side in FIG. 2, also has a pattern 1212 formed, in which a rectangular pattern that has a high optical reflectance and a rectangular pattern that has a low optical reflectance are irregularly arranged. In particular, each of the rectangular pattern with a high optical reflectance and the rectangular pattern with a low optical reflectance has various sizes depending on a position at which each of the rectangular patterns is formed. The pattern 1212 enables the information recording/reproducing apparatus 1 to obtain information about the angle direction of the rotating optical disc 100 (i.e. in which direction such a line is directed that extends from the center of the optical disc 100 toward a predetermined point in the surrounding of the disc). By this, the information recording/reproducing apparatus 1 can adjust or recognize the angle of the optical disc 100 in performing the label drawing into the label area 122.

The characteristic data recording area 121, as shown in the enlarged view thereof shown on the lower side in FIG. 2, also has a pattern 1213 formed, in which a saw-teeth pattern that has a high optical reflectance and a rectangular pattern that is disposed oppositely to the saw-teeth pattern with a high optical reflectance and that has a low optical reflectance are regularly arranged. The pattern 1213 enables the information recording/reproducing apparatus 1 to adjust the position of the optical pickup 13 in the radial direction of the optical disc 100, highly accurately. In other words, it is possible to adjust the tracking accuracy of the optical pickup 13 by the actuator 131.

More specifically, a duty ratio of the reflective light of the laser beam LB applied to the pattern 1213 allows the adjustment of the tracking accuracy of the optical pickup unit 12. When a predetermined voltage is applied to the actuator 131, the displacement of the optical pickup 13 from a position at which the duty ratio is 50% (i.e. the central position in the radial direction of the pattern 1213) is detected on the basis of the duty ratio. This operation is repeated while the voltage applied to the actuator 131 is changed. By this, it is possible to obtain a correlation between the voltage applied to the actuator 131 and the displacement of the optical pickup 13. After that, the obtained correlation is used to adjust the position of the optical pickup 13 in performing the label drawing into the label area 122.

Incidentally, the pattern 1211 formed on the relatively inner side is referred to as an inner ring. The inner ring is formed in an area with radius positions of 19.00 mm to 21.15 mm on the optical disc 100. On the other hand, the patterns 1212 and 1213 formed on the relatively outer side are referred to as an outer ring. The outer ring is formed in an area with radius positions of 21.15 mm to 21.80 mm on the optical disc 100. Each pattern formed in the characteristic data recording area 121 may be read by the information recording/reproducing apparatus 1 while the label is drawn into the label area 122, or each pattern may be read before the label is drawn into the label area 122. Each pattern may be also formed by a silk screen printing method or another method.

In the label area 122, as shown on the upper side in FIG. 2, a user's desired label (e.g. a character or letter, graphic, image, or the like) can be drawn. The desired label is drawn as a so-called black-and-white pattern, using a difference between the optical reflectance in the small area that is irradiated with the laser beam LB and the optical reflectance in the small area that is not irradiated with the laser beam LB.

### (1-2) Operation Principle

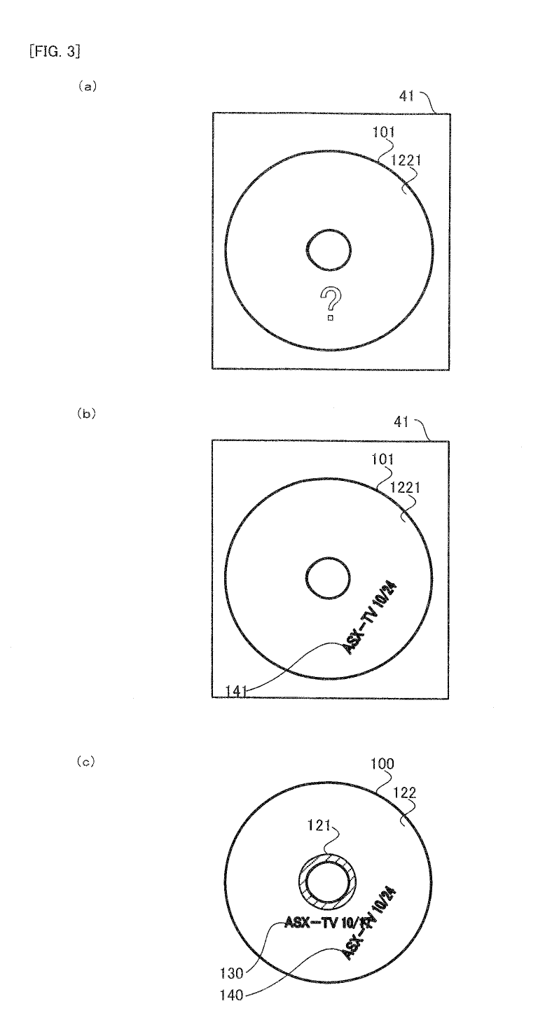

Next, with reference to FIG. 3 to FIG. 6, an explanation will be given on the operations (in particular, the drawing operation into the label layer 120) by the information recording/reproducing apparatus 1 in the example.

Firstly, with reference to FIG. 3 and FIG. 4, an explanation will be given on a difference in the label drawing between a comparison example and the first example. FIG. 3 are plan views conceptually showing a label drawn by an information recording/reproducing apparatus in the comparison example. FIG. 4 are plan views conceptually showing a label drawn by an information recording I reproducing apparatus 1 in the first example.

FIG. 3(a) shows a virtual optical disc 101 and a virtual label area 1221 which are displayed on the display device 41 before the desired pattern is prepared. In the comparison example, since drawing information up to the previous time is not managed, the label drawn up to the previous time is not displayed on the display device 41.

FIG. 3(b) shows a current virtual label 141 prepared this time as the desired pattern, on the virtual label area 1221. In the comparison example, since the placement and size of the label drawn up to the pervious time are not clear, the placement and size of the current virtual label 141 are sensuously determined by a user.

FIG. 3(c) shows a current label 140 actually drawn in the label area 122 on the basis of the current virtual label 141. In the comparison example, since the current virtual label 141 is sensuously determined, the current label 140 and the previous label 130 are drawn with them partially overlapping.

In contrast to the comparison example, in the first example, FIG. 4(a) shows the virtual optical disc 101, the virtual label area 1221, and a previous virtual label 131 which are displayed on the display device 41 before the desired pattern is prepared. In the example, in particular, since the drawing information up to the previous time is managed, the pervious virtual label 131 drawn up to the previous time is displayed on the display device 41.

FIG. 4(b) shows the current virtual label 141 prepared this time as the desired pattern, on the virtual label area 1221, together with the previous virtual label 131. In the example, in particular, a user can determine the placement and size of the current virtual label 141 while visually recognizing the previous virtual label 131.

FIG. 4(c) shows the current label 140 actually drawn in the label area 122 on the basis of the current virtual label 141. At this time, since the current virtual label 141 is determined while the previous virtual label 131 is visually recognized, the current label 140 can be drawn such that it is properly disposed not to overlap the previous label 130.

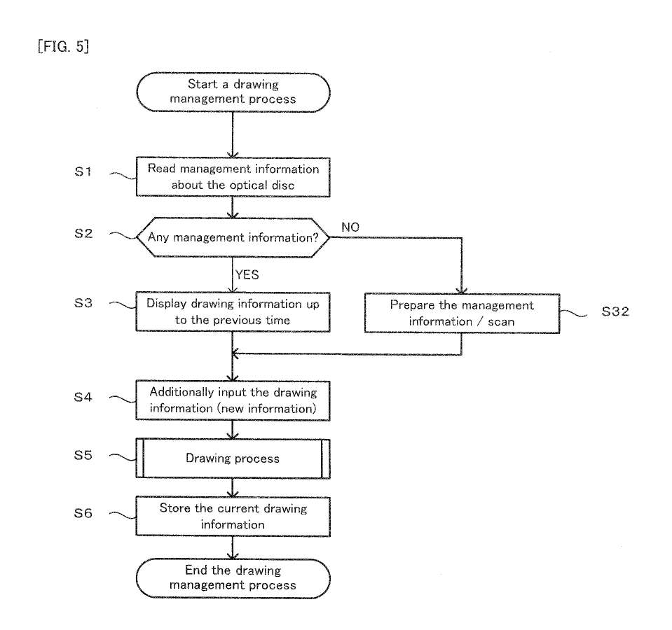

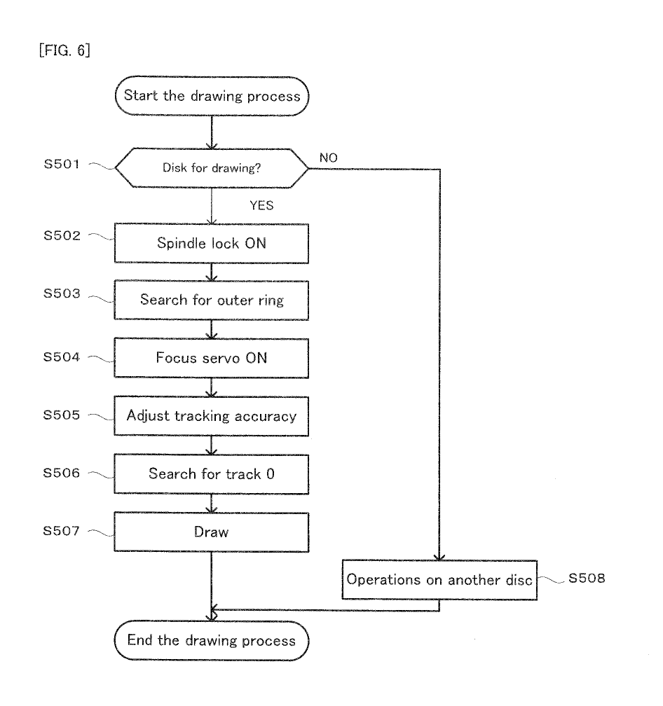

Next, with reference to FIG. 5 and FIG. 6 in addition to FIG. 4(a) to FIG. 4(c), an explanation will be given on a specific operation processing of the label drawing. FIG. 5 is a flowchart conceptually showing a flow of a drawing management processing in the first example. FIG. 6 is a flowchart conceptually showing a flow of a drawing processing in the drawing management processing in the first example.

In FIG. 5, firstly, the system controller 31 reads the management information about the optical disc 100 (corresponding to identification information about the optical disc 100) which is set on the spindle motor 11 and which is a label drawing target, from the memory 32 (step S1). Specifically, a unique ID prerecorded on the optical disc 100 is read, and the management information associated with the unique ID is read from the memory 32.

At this time, it is judged by the system controller 31 whether or not there is the management information (step S2). If there is the management information (the step S2: YES), the drawing information up to the previous time (i.e. including the previous virtual label 131) is read from the memory 32 and is displayed on the display device 41 (step S3). This is shown in FIG. 4(a).

On the other hand, if there is no management information (the step S2: NO), it is regarded as initial label drawing, and default management information is newly prepared (step S32). Incidentally, in anticipation of a case where there is no management information although it is not the initial label drawing (e.g. if the unique ID is not read from the optical disc 100), the label drawn in the label area 122 up to the previous time may be scanned and displayed on the display device 41 by applying/receiving the laser beam LB to from the label area 122 with a first power.

Then, while confirming the previous virtual label 131 on the display device 41, a user additionally prepares the current virtual label 141 through the input device 42 (step S4). This is shown in FIG. 4(b). Incidentally, of course, if the current label drawing is the first drawing on the optical disc 100, the label is newly prepared.

Then, a drawing processing of drawing the prepared current virtual label 141 as the desired label into the label area 122 is performed (step S5). By this, the current label 140 is drawn such that it is properly disposed not to overlap the previous label 130. This is shown in FIG. 4(c). Incidentally, the details of the drawing processing will be described later with reference to FIG. 6.

Lastly, the drawing information including the current virtual label 141 is stored into the memory 32 (step S6). The drawing information stored in this manner is used in the management of the subsequent drawing status.

Now, with reference to FIG. 6, the drawing processing in the step S5 will be detailed.

In FIG. 6, firstly, it is judged whether or not the optical disc loaded on the information recording/reproducing apparatus 1 is the optical disc 100 on which the label drawing can be performed by the information recording/reproducing apparatus 1 (i.e. the aforementioned optical disc 100 in the example), under the control of the system controller 31 (step S501).

As a result of the judgment in the step S501, if it is judged that the optical disc loaded on the information recording/reproducing apparatus 1 is not the optical disc 100 on which the label drawing can be performed by the information recording/reproducing apparatus 1 (the step S501: No), operations in a step S502 to a step S507 which will be explained below are not performed, and an operation according to the loaded optical disc is performed (step S508).

On the other hand, as a result of the judgment in the step S501, if it is judged that the optical disc loaded on the information recording/reproducing apparatus 1 is the optical disc 100 on which the label drawing can be performed by the information recording/reproducing apparatus 1 (the step S501: Yes), then the spindle motor 11 is locked under the control of the spindle controller 18 (step S502). Specifically, the inner ring including the aforementioned pattern 1211 is read, and the rotational speed of the spindle motor 11 (in other words, the rotational speed of the optical disc 100) is adjusted in accordance with the reading result. After that, the rotational speed of the spindle motor 11 is kept constant.

Then, after the outer ring including the aforementioned patterns 1212 and 1213 is searched for (step S503), focus servo is turned ON (step S504).

Then, the outer ring searched for in the step S503 is used to adjust a tracking accuracy (step S505).

Then, a track 0 which is a position to start the drawing of the desired label into the label area 122 is searched for (step S506). The label layer 120 does not have a physical track, so the track 0 is virtual; however, for example, it exists in a position with a radial position of 23.80±0.03 mm on the optical disc 100.

Then, the desired label is drawn into the label area 122 by a track drawing process detailed later (step S507).

As is seen above, according to the information recording/reproducing apparatus 1 in the example, the current label 140 is drawn such that it is properly disposed not to overlap the previous label 130. As described above, it is more certain that the overlap of each label can be avoided, and it is extremely useful in practice.

### (2) Second Example

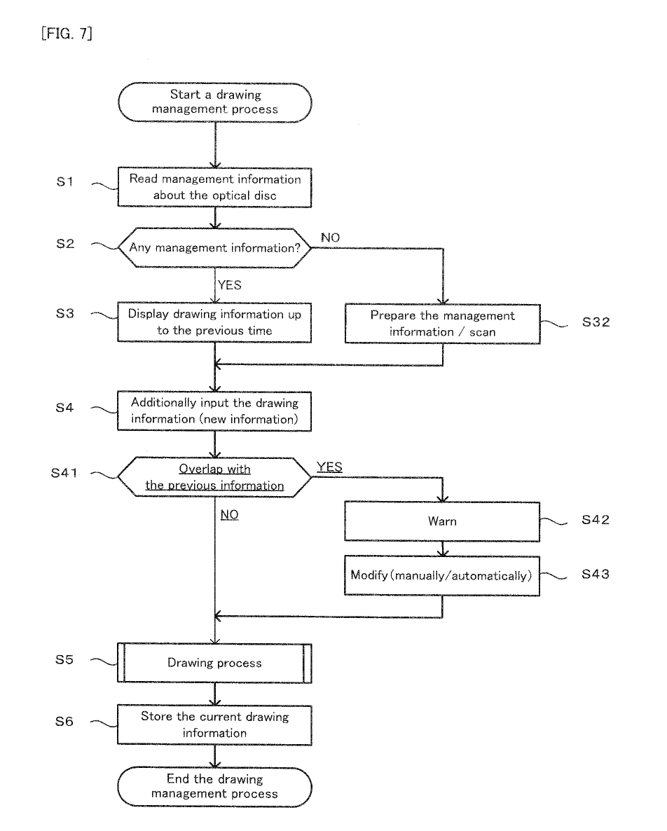

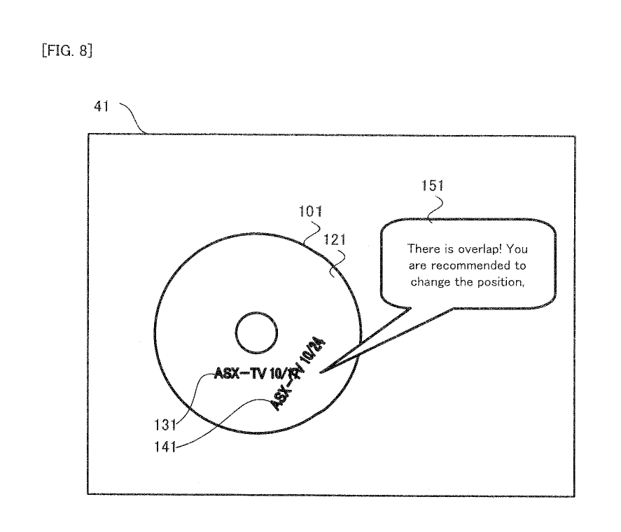

Next, with reference to FIG. 7 and FIG. 8 in addition to FIG. 1 to FIG. 6, an explanation will be given on the basic structures of an information recording/reproducing apparatus in a second example and an optical disc which is a target for the operations by the information recording/reproducing apparatus.

In the second example, in particular, in contrast to the first example, a warning is given if the current virtual label 141 overlaps the previous virtual label 131.

### (2-1) Basic Structure

Firstly, the basic structure of the information recording/reproducing apparatus in the second example will be described. Here, the information recording/reproducing apparatus in the second example may have the same basic structure as the information recording/reproducing apparatus 1, and the optical disc may have the same basic structure as the optical disc 100. Thus, the same constituents will carry the same referential numerals, and the detailed explanation thereof will be omitted as occasion demands.

### (2-2) Operation Principle

Next, with reference to FIG. 7 and FIG. 8, an explanation will be given on the operations (in particular, a warning operation) by the information recording/reproducing apparatus 1 in the second example. FIG. 7 is a flowchart conceptually showing a flow of a drawing management processing in the second example. FIG. 8 is a plan view showing a warning screen in the second example. Here, while an explanation is given on the operations by the information recording I reproducing apparatus 1 in the second example on the whole with reference to FIG. 7, a more detailed explanation is given with reference to FIG. 8, as occasion demands. Incidentally, of the operation processings of the information recording/reproducing apparatus 1 in the second example, the same operation processings as in the steps shown in FIG. 5 will carry the same referential numerals, and the detailed explanation thereof will be omitted as occasion demands.

In FIG. 7, as described above with reference to FIG. 5, if the current virtual label 141 is additionally prepared (the step S4), it is judged by the system controller 31 whether or not the current virtual label 141 overlaps the previous virtual label 131 (step S41). Specifically, the areas occupied by the both labels are expressed as coordinate data, and the presence or absence of the overlap of the both areas is judged. At this time, the extent of allowed overlap may be variable at multiple stages.

Here, if it is judged that the current virtual label 141 does not overlap the previous virtual label 131 (the step S41: NO), there is no problems, and the drawing processing is performed as it is (step S5).

On the other hand, if it is judged that the current virtual label 141 overlaps the previous virtual label 131 (the step S41: YES), the current label 140 will be drawn with it overlapping the previous label 130 if nothing is done. Thus, the system controller 31 instructs the display device 41 to display a warning (step S42). As a result, for example, a warning 151 is displayed on the display device 41, which is “There is overlap! You are recommended to change the position”, as shown in FIG. 8.

In response to the warning 151, the placement and size of the current virtual label 141 are modified (step S43). This modification may be performed manually by a user through the input device 42, or automatically. If the modification is automatically performed, for example, the system controller 31 may specify a place which accommodates the current virtual label 141 from an area in which the previous virtual label 131 is not drawn of the virtual label area 1221, and the system controller 31 rearranges the current virtual label 141 in the specified place. Alternatively, a pattern for defining the placement (e.g. arranging each label in a tandem shape or along the circumference, or the like) and the size (e.g. specifying upper and lower limit values in vertical and horizontal directions of each label, upper and lower limit values of a font size, or the like) may be specified in advance, and the modification may be performed automatically in accordance with the pattern. Incidentally, if the both labels are overlapped intentionally, of course, the warning 151 can be ignored.

As is seen above, according to the information recording/reproducing apparatus 1 in the second example, even if a user disposes the current virtual label 141 with it overlapping the previous virtual label 131 and misses the fact, the warning 151 is displayed. As described above, it is more certain that the overlap of each label can be avoided, and it is extremely useful in practice.

Moreover, the aforementioned example is explained with a light scribe technology in mind; however, it is obviously possible to receive the aforementioned effects by adopting the aforementioned construction in various applications such as other technologies for drawing the label (e.g. label flash, DiscT@2).

### (3) Third Example

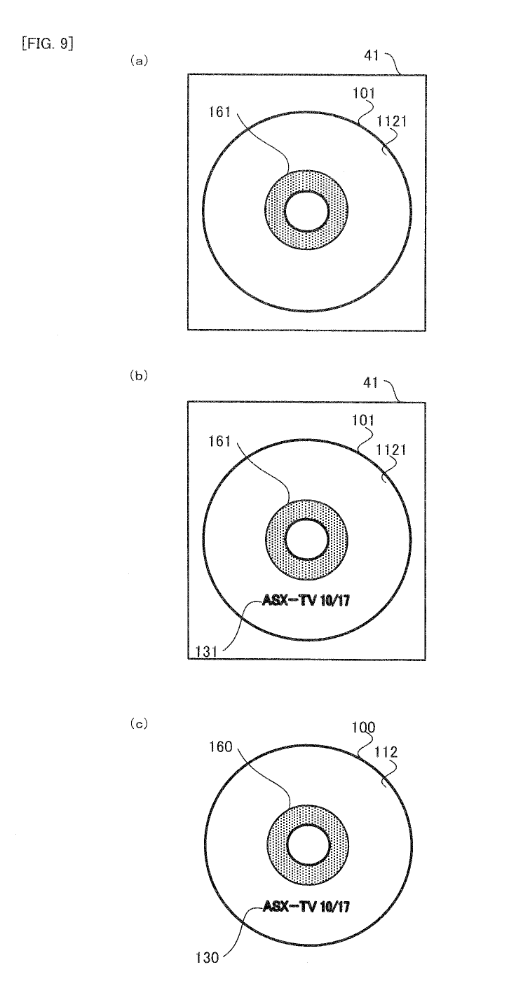

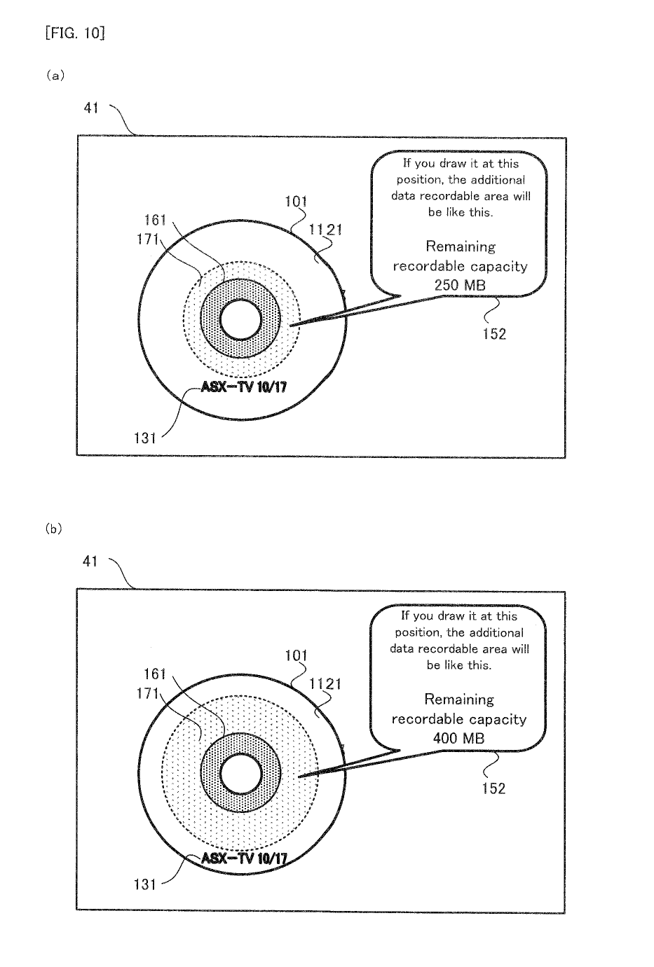

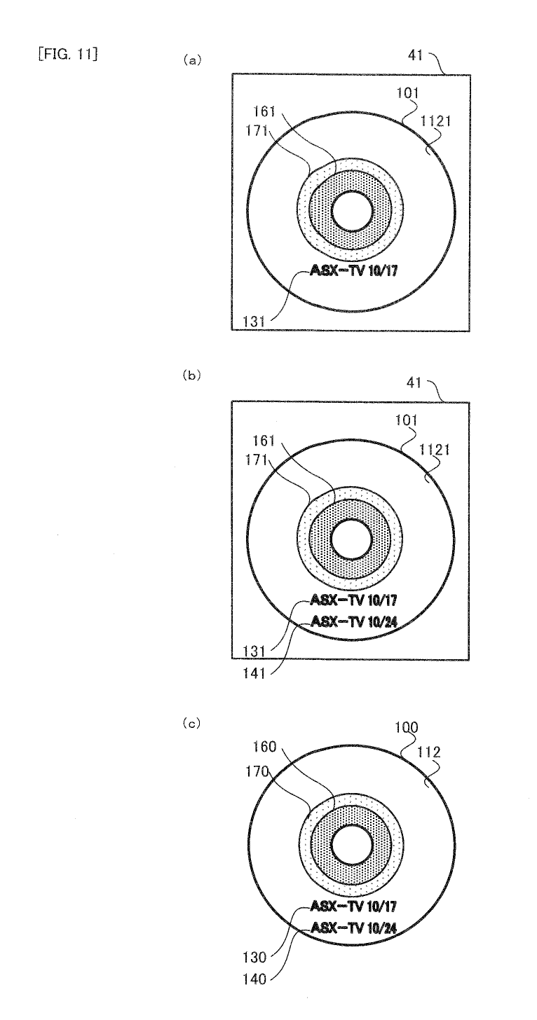

Next, with reference to FIG. 9 to FIG. 11 in addition to FIG. 1 and FIG. 2, an explanation will be given on the basic structure of an information recording/reproducing apparatus in a third example. FIG. 9 are plan views conceptually showing that a data recorded area on a recording surface of an optical disc in the third example is displayed on the display device. FIG. 10 are plan views showing that a remaining recordable capacity is displayed on the display device in the third example. FIG. 11 are plan views conceptually showing that a plurality of data recorded areas and a drawn area on the recording surface of the optical disc in the third example are displayed on the display device. Incidentally, the structure in the third example may be the same as in the aforementioned first or second example; however, since the label is drawn into the recording layer 110, the characteristic data recording area 121 or information corresponding to it is disposed on the recording surface side.

In the third example, in particular, in contrast to the aforementioned examples, the label is drawn into the record layer 110, like DiscT@2. In other words, the desired pattern is drawn onto the recording surface of the optical disc 100. Specifically, if the drawing is performed on the recording surface side, how far the data is recorded is read from a management area of the optical disc 100, and an application for drawing (i.e. the system controller 31) performs a process for drawing, in an area that does not overlap the management area. However, as described above using the comparison example, normally, information indicating in which area the drawing is performed is not stored. Thus, if the data is additionally recorded, the overlap with a data area can be avoided, but the data possibly overlaps a drawn area. In order to avoid the situation, in addition to the drawing history, the data recorded area on the recording surface is also recorded as the management information. By using this management information, it is possible to improve convenience in the drawing and data recording. This will be detailed below, with reference to an example in which the previous and current labels are drawn.

The information recording/reproducing apparatus 1 in the third example records the data from the inner circumferential side of the optical disc 100. Various information about the data is recorded into the management area (not illustrated) of the optical disc 100. With this, information indicating up to which track the data recorded area covers on the recording surface is recorded into the memory 32 as one portion of the management information in association with the identification information unique to the optical disc 100.

Moreover, when the previous label 130 is drawn, the following processing is performed. Firstly, the identification information unique to the optical disc 100 is read, and it is read where the data recorded area (i.e. a first data area 160 described later) begins and ends, on the basis of the management information associated with the read identification information. Then, as shown in FIG. 9(a), an area corresponding to the first data area 160 is displayed on the display device 41 as a virtual first data area 161 on a virtual recording area 1121. In other words, an area other than the virtual first data area 161 is displayed as a drawable area. Thus, as shown in FIG. 9(b), a user can determine the placement, size, and the like of the previous label 131 so as not to overlap the data recording area. In accordance with the determination, as shown in FIG. 9(c), the previous label 130 is drawn onto an actual recording surface (and label area) 112. At this time, since the previous label 130 is drawn without overlapping the first data area 160, the deterioration of recording quality is avoided.

Here, from the viewpoint of a data additional recording capacity, the remaining recordable capacity of the optical disc 100 is preferably calculated and displayed for a user in determining the placement, size, and the like of the previous virtual label 131 as described above. For example, as shown in FIG. 10(a), when a user disposes the previous virtual label 131 at a predetermined position through the input device 42, the remaining recordable capacity may be calculated, and a balloon 152 indicating that “the remaining recordable capacity is 250 MB” may be displayed on the display device 41. In addition, if a user who confirmed this display further rearranges the previous virtual label 131 on the outer circumferential side, the remaining recordable capacity is recalculated in accordance with that, and as a result, the balloon 152 indicating that “the remaining recordable capacity is 400 MB” may be displayed on the display device 41. If the remaining recordable capacity can be confirmed as described above, it is possible to determine the placement, size, and the like of the previous virtual label 131, while ensuring the data additional recording capacity as much as possible.

As described above, if the previous label 130 is drawn, the application for drawing updates the drawn area information which is one portion of the management information. By this, it is possible to determine the data recorded area and the drawn area of the optical disc 100. For example, if a drawing area is set near the outer circumference, it is possible to additionally record the data because there is a free space after the data recorded area. If the management information is updated on the basis of the additionally recorded information, it is possible to display a virtual second data area 171 as shown in FIG. 11(a), and it is useful in determining the placement of the label drawing this time. In other words, since a user can easily recognize the plurality of data recorded areas (in this case, the virtual first data area 161 and the virtual second data area 171) and the drawn area (in this case, the previous virtual label 131), the user can determine the placement, size, and the like of the current virtual label 141 so as not to overlap the recorded area, as shown in FIG. 11(b). In accordance with the determination, as shown in FIG. 11(c), it is possible to additionally draw the current label 140 into the free space, easily.

As is seen above, according to the information recording/reproducing apparatus 1 in the example, it is possible to preferably avoid the deterioration of the drawing quality or recording quality in the additional drawing or the additional data recording, and it is extremely useful in practice.

The present invention is not limited to the aforementioned examples, but various changes may be made, if desired, without departing from the essence or spirit of the invention which can be read from the claims and the entire specification. A drawing apparatus and method, and a computer program, all of which involve such changes, are also intended to be within the technical scope of the present invention.

### INDUSTRIAL APPLICABILITY

The drawing apparatus and method and the computer program of the present invention can be applied to an information recording apparatus which can draw a pattern, such as a character or a letter, a graphic, and an image, onto any one of the both surfaces of a recording medium such as a DVD. Moreover, they can be also applied to an information recording apparatus or the like which is mounted on or connected to various computer equipment for consumer use or for commercial use

1. A drawing apparatus for performing a drawing processing for drawing a desired pattern onto a label surface provided for a recording medium, said drawing apparatus comprising:
an inputting device for receiving the desired pattern to be drawn, from a user;
a drawing device for drawing the received desired pattern onto the label surface by applying a laser beam to the label surface; and
a management information recording device for recording the drawn desired pattern and management information associated with identification information unique to the recording medium provided with the label surface on which the desired pattern is drawn, every time the desired pattern is drawn onto the label surface.

2. The drawing apparatus according to claim 1, further comprising a displaying device for displaying the desired pattern drawn on the recording medium in the drawing processing performed previous time or before the previous time, as a drawing history, on the basis of the recorded management information.

3. The drawing apparatus according to claim 2, further comprising a judging device for performing a judgment processing of judging whether or not there is overlap on the label surface between the drawing history and the desired pattern received in a current drawing processing.

4. The drawing apparatus according to claim 3, further comprising a warning device for giving a predetermined warning to the user if it is judged in the judgment processing that there is the overlap.

5. The drawing apparatus according to claim 3, further comprising a modifying device for displacing or reducing the desired pattern received in the current drawing processing so as to reduce extent of the overlap if it is judged in the judgment processing that there is the overlap.

6. The drawing apparatus according to claim 2, further comprising a reading device for reading the drawing history by optically scanning the label surface if the management information is not recorded,
said displaying device displaying the read desired pattern.

7. The drawing apparatus according to claim 1, further comprising a data recording device which can record data onto a recording surface, only once or additionally, if said drawing apparatus performs the drawing onto the recording surface of the recording medium as the label surface,
said management information recording device recording a data recorded area on the recording surface, in addition to the drawn desired pattern, as the management information.

8. The drawing apparatus according to claim 7, wherein said displaying device further displays the data recorded area.

9. The drawing apparatus according to claim 8, wherein said displaying device further displays an area in which data is scheduled to be additionally recorded by said data recording device.

10. The drawing apparatus according to claim 7, further comprising a calculating device for calculating a remaining recordable capacity corresponding to an area in which data additional recording is possible on the recording surface, on the basis of the recorded management information.

11. The drawing apparatus according to claim 10, wherein said displaying device further displays the calculated remaining recordable capacity.

12. A drawing method in a drawing apparatus for performing a drawing processing for drawing a desired pattern onto a label surface provided for a recording medium, said drawing method comprising:
an inputting process of receiving the desired pattern to be drawn, from a user;
a drawing process of drawing the received desired pattern onto the label surface by applying a laser beam to the label surface; and
a management information recording process of recording the drawn desired pattern and management information associated with identification information unique to the recording medium provided with the label surface on which the desired pattern is drawn, every time the desired pattern is drawn onto the label surface.

13. A computer-readable medium containing a computer program for controlling a computer provided in a drawing apparatus for performing a drawing processing for drawing a desired pattern onto a label surface provided for a recording medium, said drawing apparatus comprising: an inputting device for receiving the desired pattern to be drawn, from a user; a drawing device for drawing the received desired pattern onto the label surface by applying a laser beam to the label surface; and a management information recording device for recording the drawn desired pattern and management information associated with identification information unique to the recording medium provided with the label surface on which the desired pattern is drawn, every time the desired pattern is drawn onto the label surface,
said computer program making a computer function as at least said management information recording device.
